(19) United States
(12) Patent Application Publication
(10) Pub. No.: US 2008/0156285 A1
(43) Pub. Date: Jul. 3, 2008

(54) ENGINE PRE-HEATER

(76) Inventor: Ray King, Pickering (CA)

Correspondence Address: SCHMEISER, OLSEN & WATTS, 22 CENTURY HILL DRIVE, SUITE 302, LATHAM, NY, 12110, US

(21) Appl. No.: 11/427,545

(22) Filed: Jun. 29, 2006

(51) Int. Cl. F02N 17/02

(52) U.S. Cl. 123/142.5 E

(57) ABSTRACT

An engine pre-heater and heater assembly comprising a housing having a passage extending therethrough for passage of coolant through the pre-heater. The housing provides at least one opening defined therein separate from the passage, and an electric heating element is inserted therein, the heating element projecting into the passage whereby the heating element is in direct contact with the coolant to heat it. The heating element is supplied with electrical power from a power source for enabling the heating element to heat the coolant. In an alternative embodiment, an air blower directs heat generated by the heated coolant, or by air heated in the passage (dry heat), to an area external to the heater assembly.

This invention relates generally to engine pre-heaters and to a heater assembly, and more particularly to an improved engine pre-heater for heating engine coolant to warm the engine when it is not running, and to a related heater assembly.

### DESCRIPTION OF THE PRIOR ART

It is well known that engines are difficult to start and subject to excessive wear when operated in cold, northern areas. Various kinds of engine pre-heaters that heat engine coolant and/or engine oil or fuel have been used to alleviate this problem. However, these pre-heaters have not always been reliable, or require the use of natural gas, propane, oil or other fuels to operate. As such, these types of devices are not environmentally friendly or pollution free.

Other types of engine pre-heaters have attempted to circumvent this problem by utilizing electrical elements internally positioned within the pre-heater, whereby coolant can be heated by the electrical element. U.S. Pat. Nos. 5,408,960 (Woytowich) and 4,770,134 (Foreman et al) are examples of such devices. However, these arrangements feature electrical elements that are internally positioned within the tank or chamber, and do not allow for easy removal of the electrical element from the pre-heater, should maintenance or replacement of the electrical element be required. In such maintenance or replacement situations, the entire pre-heater would be required to be removed to access the internal electrical element, thereby making maintenance and replacement of such pre-heater components difficult and complicated.

Thus, there is a further need for an improved environmentally friendly engine pre-heater which has a generally uncomplicated and simple design, which maybe installed easily on an engine and is durable and reliable, and which possesses easily removable or replaceable coolant heating elements. There is also a further need for an improved heater assembly which can be easily installed in a car, house, swimming pool or the like. In this regard, the present invention substantially fulfills this need.

### SUMMARY OF THE INVENTION

It is an object of the present invention to provide an improved engine pre-heater and heater assembly which is environmentally friendly, which has a generally uncomplicated and simple design, and which may be installed easily on an engine.

It is another object of the present invention to provide an improved engine pre-heater and heater assembly which is durable and reliable, and which possesses easily removable or replaceable coolant heating elements.

According to one aspect of the present invention, there is provided an engine pre-heater, the pre-heater being of a type adapted to be connected between an engine and a radiator by a hose comprising a housing having a passage extending therethrough for passage of coolant through the housing, the housing further comprising at least one opening defined therein separate from the passage; and a removable electric heating element inserted into the at least one opening, the heating element projecting into the passage of the housing whereby the electric heating element is in direct contact with the coolant, the electric heating element being supplied with electrical power from an electrical power source for enabling the electric heating element to heat the coolant.

According to another aspect of the present invention, there is provided a heater assembly, the heater assembly being of a type adapted to be connected between a radiator providing coolant and a pump for circulating the coolant, comprising a housing having a passage extending therethrough for passage of the coolant through the housing, the housing further comprising at least one opening defined therein separate from the passage; an electric heating element inserted and mounted into the at least one opening, the heating element projecting into the passage of the housing whereby the electric heating element is in direct contact with the coolant; a power source in communication with the heater assembly, for supplying the electric heating element and the pump with power, for enabling the electric heating element to heat the coolant and the pump to circulate the coolant; and an air blower, the air blower including a blower motor and fan blades driven by the blower motor for directing heat generated by the heated coolant to an area external to the heater assembly, the air blower being supplied with power from the power source.

According to another aspect of the present invention, there is provided a heater assembly comprising a housing having an air passageway extending therethrough for passage of air through the housing, the housing further comprising at least one opening defined therein separate from the air passageway; an electric heating element inserted and mounted into the at least one opening, the heating element projecting into the the air passageway of the housing whereby the electric heating element is in direct contact with air in the air passageway; a power source in communication with the heater assembly, for supplying the electric heating element with power, for enabling the electric heating element to heat the air in the air passageway; and an air blower, the air blower including a blower motor and fan blades driven by the blower motor for directing the heated air from the air passageway to an area external to the heater assembly, the air blower being supplied with power from the power source.

The advantage of the present invention is that it provides an improved engine pre-heater which is environmentally friendly, which has a generally uncomplicated and simple design, and which may be installed easily on an engine

Yet another advantage of the present invention is to provide an improved engine pre-heater and heater assembly which is durable and reliable, and which possesses easily removable or replaceable coolant heating elements.

### BRIEF DESCRIPTION OF THE DRAWINGS

A preferred embodiment of the present invention is described below with reference to the accompanying drawings, in which:

FIG. 1 is a perspective view of an embodiment of the engine pre-heater of the present invention;

FIG. 2 is a perspective view of an embodiment of the engine pre-heater of the present invention shown in FIG. 1, shown with glow plugs inserted in the housing and in direct contact with the coolant;

FIG. 3 is a schematic diagram of an embodiment of the engine pre-heater of the present invention in place within a car engine; and

FIG. 4 is a schematic diagram of an alternative embodiment of the present invention, utilizing glow plugs to heat radiator water whereby a fan blower can then direct the heat created to heat a house or other enclosed structure.

### DESCRIPTION OF THE PREFERRED EMBODIMENT

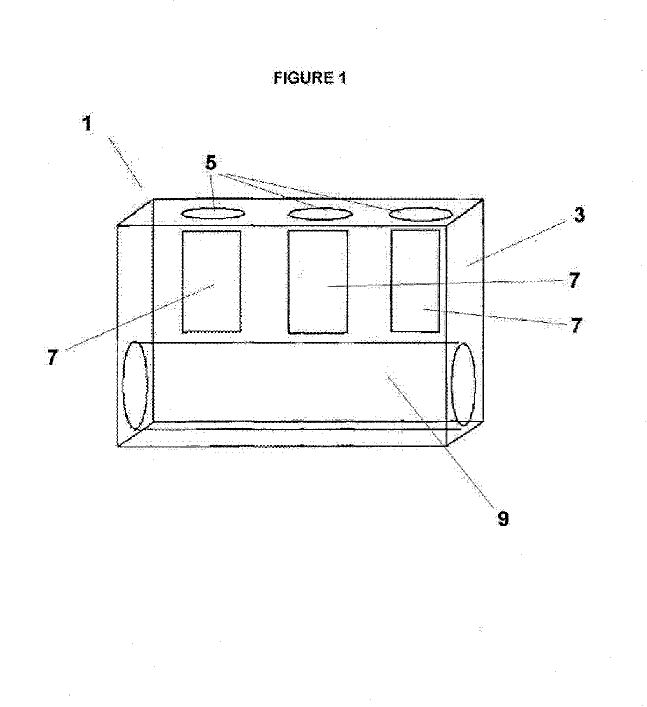

In the preferred embodiment, and with reference to FIG. 1, an engine pre-heater of the present invention is designated in its entirety by the reference numeral 1. The pre-heater is adapted to be attached to an engine (not shown) and connected to the engine's coolant system to heat the coolant and thereby keep the engine warm when the engine is not in operation. The pre-heater comprises a housing 3 having a passage 9 extending therethrough for passage of coolant (not shown) through the housing. As can be seen in FIG. 1, the passage 9 of the housing 3 extends substantially horizontally throughout a length of the housing. The housing 3 further comprises at least one opening 5 on an upper surface of the housing, but more preferably, a plurality of openings defined thereon, each of which are separate from the passage 9, and each of which define an internally defined chamber 7 within the body of the housing. As can be seen in FIG. 1, the housing is adapted to be mounted generally horizontally. As can also be readily seen in FIG. 1, the housing 3 possesses an inlet at one end of the housing, and an outlet at the opposite end of the housing. Preferably, the housing 3 is made of metal, though it is conceivable that other materials could also be utilized, as would be apparent to one skilled in the art.

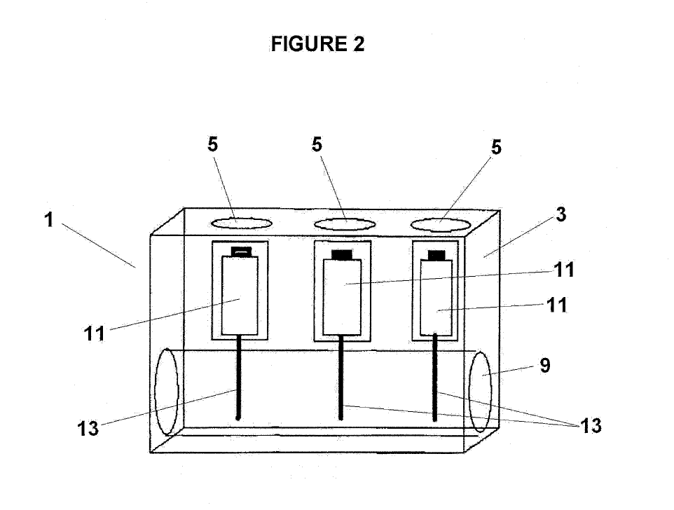

As can be seen in FIG. 2, an electric heating element 11 is inserted through the opening 5 on the upper surface of the housing 3, so as to reside within the internally defined chambers 7 within the body of the housing. Preferably, the electric heating element is a glow plug, and, as such, is easily removable and replaceable if required. A lower end of the heating element 13 projects into the passage 9 of the housing 3 whereby the electric heating element 11 is in direct contact with the coolant.

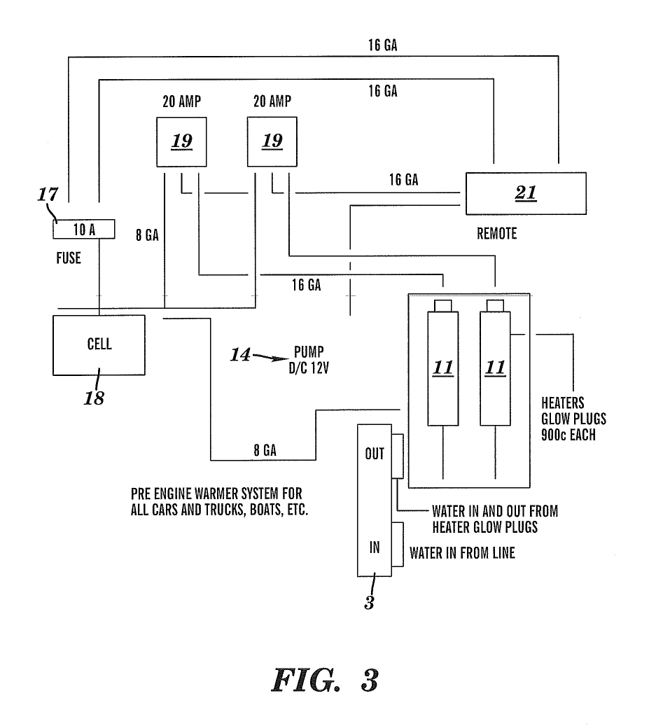

FIG. 3 represents an electrical schematic diagram of one embodiment of an arrangement of the pre-heater of the present invention. The electric heating elements 11 in the housing 3 are supplied with electrical power from a power source 15 for enabling the electric heating elements to heat the coolant (not shown), the coolant of course being circulated by pump 13. The pre-heater can be activated by a remote device 21 by a user, whereby the cell 15, via fuse 17, activates the electric heating elements 11 to heat the coolant, and this heat can then be transferred by way of heat exchanger 19, pre-warming the engine and pre-heating the inside of the vehicle.

In a preferred embodiment, the power source is an electrical battery type power source, particularly for the engine pre-heater of the present invention, though it is conceivable that, alternatively, solar power cells, a/c power, wind generated power sources or the like could also be used, as would be apparent to one skilled in the art, particularly with the heater assembly of the present invention for heating enclosed structures. Of course, it would be readily apparent that such a power cell could also be re-energized or re-charged also, as is known in the art.

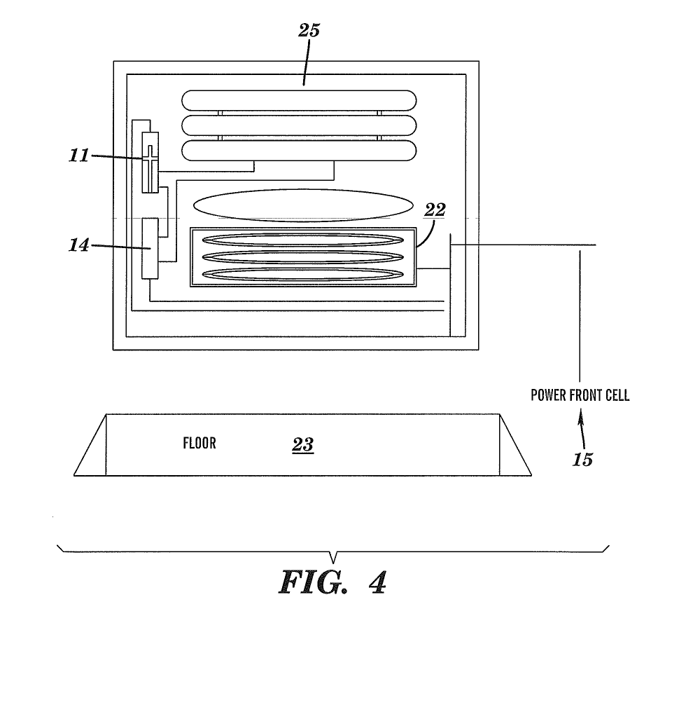

In an alternative embodiment of the present invention, a heater assembly is provided, an arrangement of which could be used in a home or other similar enclosed structure. With reference to FIG. 4, coolant can be provided by a radiator 25. A pump 13 is used to circulate the coolant. The power course (or cell) 15 activates the electric heating elements 11 to heat the coolant being circulated, and this heat can then be transferred by way of, for example, an air blower 21, the air blower including a blower motor and fan blades driven by the blower motor for directing heat generated by the heated coolant to an area external to the heater assembly. Of course, the air blower 21 is supplied with power from the power source 15. The heater assembly is shown in FIG. 4 as being designed for placement within, for example, a floor space 23.

In another alternative embodiment of the present invention, coolant can be omitted, and dry heat, provided from the electric heating elements 11, can be utilized. In this embodiment (not shown) the housing would preferably have an air passageway extending therethrough for passage of air through the housing, the housing further comprising openings defined therein separate from the air passageway. Electric heating elements would be inserted and mounted into the openings, the heating so as to project into the the air passageway of the housing whereby the electric heating elements are in direct contact with air in the air passageway. A power source in communication with the heater assembly supplies the electric heating elements with power, for enabling the electric heating elements to heat the air in the air passageway. An air blower, for example, or other such device, could then direct the heated air from the air passageway to an area external to the heater assembly, such as a house or other enclosed structure, the air blower being supplied with power from the power source.

In an alternative embodiment, the pre-heater can further comprise a thermostatic control (not shown) in association with the electric heating element and the coolant in the housing, wherein the thermostatic control is adapted to turn the electric heating element off when a temperature of the engine coolant exceeds a pre-determined level. Preferably, the thermostatic control is positioned relative to the inlet of the housing. Further, the thermostatic control can also thus turn the electric heating element on when a temperature of the engine coolant falls below a pre-determined level.

The present invention has been described herein with regard to preferred embodiments. However, it will be obvious to persons skilled in the art that a number of variations and modifications can be made without departing from the scope of the invention as described herein.

1. An engine pre-heater, the pre-heater being of a type adapted to be connected between an engine and a radiator by a hose comprising:
a housing having a passage extending therethrough for passage of coolant through the housing;
a plurality of openings defined within the housing, each of which are separate from the passage; and
an electric heating element inserted into each of the plurality of openings, the heating element projecting into the passage of the housing whereby the electric heating element is in direct contact with the coolant, the electric heating element being supplied with electrical power from an electrical power source for enabling the electric heating element to heat the coolant.

2. The engine pre-heater of claim 1, wherein the housing is adapted to be mounted generally horizontally.

3. The engine pre-heater of claim 1, wherein the housing further comprises an inlet adjacent one end of the housing for flow of engine coolant into the housing and an outlet adjacent the opposite end of the housing for flow of heated engine coolant out of the housing.

4. The engine pre-heater of claim 1, wherein the electric heating element is a glow plug.

5. The engine pre-heater of claim 3, wherein the pre-heater further comprises a thermostatic control in association with the electric heating element and the coolant in the housing, wherein the thermostatic control is adapted to turn the electric heating element off when a temperature of the engine coolant exceeds a pre-determined level.

6. The engine pre-heater of claim 5, wherein the thermostatic control is positioned relative to the inlet of the housing.

7. The engine pre-heater of claim 5, wherein the thermostatic control is adapted to turn the electric heating element on when a temperature of the engine coolant falls below a pre-determined level.

8. The engine pre-heater of claim 1, wherein the passage of the housing extends substantially horizontally throughout a length of the housing.

9. The engine pre-heater of claim 1, further comprising:
a remote device to activate the electrical heating element from a distance.

10. The engine pre-heater of claim 1, wherein the electric heating element is removable.

11. The engine pre-heater of claim 1, wherein the electrical power source is an electrical battery.

12. The engine pre-heater of claim 1, wherein the electrical power source is a solar power cell.

13. The engine pre-heater of claim 1, wherein the housing is made of metal.

14. A heater assembly, the heater assembly being of a type adapted to be connected between a radiator providing coolant and a pump for circulating the coolant, comprising:
a housing having a passage extending therethrough for passage of the coolant through the housing, the housing further comprising at least one opening defined therein separate from the passage;
an electric heating element inserted and mounted into the at least one opening, the heating element projecting into the passage of the housing whereby the electric heating element is in direct contact with the coolant;
a power source in communication with the heater assembly, for supplying the electric heating element and the pump with power, for enabling the electric heating element to heat the coolant and the pump to circulate the coolant; and
an air blower, the air blower including a blower motor and fan blades driven by the blower motor for directing heat generated by the heated coolant to an area external to the heater assembly, the air blower being supplied with power from the power source.

15. The heater assembly of claim 14, wherein the pre-heater further comprises a thermostatic control in association with the electric heating element and the coolant in the housing, wherein the thermostatic control is adapted to turn the electric heating element off when a temperature of the engine coolant exceeds a pre-determined level.

16. The heater of claim 15, wherein the pre-heater further comprises a thermostatic control in association with the electric heating element and the coolant in the housing, wherein the thermostatic control is adapted to turn the electric heating element off when a temperature of the engine coolant exceeds a pre-determined level.

17. The heater assembly of claim 16, wherein the thermostatic control is adapted to turn the electric heating element on when a temperature of the engine coolant falls below a pre-determined level.

18. The heater assembly of claim 14, wherein the electric heating element is a glow plug.

19. The heater assembly of claim 14, the housing having an inlet adjacent one end of the housing for flow of coolant into the housing and an outlet adjacent the opposite end of the housing for flow of heated coolant out of the housing.

20. A heater assembly comprising:
a housing having an air passageway extending therethrough for passage of air through the housing, the housing further comprising at least one opening defined therein separate from the air passageway;
an electric heating element inserted and mounted into the at least one opening, the heating element projecting into the the air passageway of the housing whereby the electric heating element is in direct contact with air in the air passageway;
a power source in communication with the heater assembly, for supplying the electric heating element with power, for enabling the electric heating element to heat the air in the air passageway; and
an air blower, the air blower including a blower motor and fan blades driven by the blower motor for directing the heated air from the air passageway to an area external to the heater assembly, the air blower being supplied with power from the power source.

21. An engine pre-heater, the pre-heater being of a type adapted to be connected between an engine and a radiator by a hose comprising:
a housing having a passage extending therethrough for passage of coolant through the housing, the housing further comprising at least one opening defined therein separate from the passage;
an electric heating element inserted into the at least one opening, the heating element projecting into the passage of the housing whereby the electric heating element is in direct contact with the coolant, the electric heating element being supplied with electrical power from an electrical power source for enabling the electric heating element to heat the coolant; and
a thermostatic control in association with the electric heating element and the coolant in the housing, wherein the thermostatic control is adapted to turn the electric heating element off when a temperature of the engine coolant exceeds a pre-determined level, and wherein the thermostatic control is adapted to turn the electric heating element on when a temperature of the engine coolant falls below a pre-determined level.

22. The engine pre-heater of claim 21, wherein the housing is adapted to be mounted generally horizontally.

23. The engine pre-heater of claim 21, wherein the housing further comprises an inlet adjacent one end of the housing for flow of engine coolant into the housing and an outlet adjacent the opposite end of the housing for flow of heated engine coolant out of the housing.

24. The engine pre-heater of claim 21, wherein the electric heating element is a glow plug.

25. The engine pre-heater of claim 24, wherein the thermostatic control is positioned relative to the inlet of the housing.

26. The engine pre-heater of claim 21, wherein the passage of the housing extends substantially horizontally throughout a length of the housing.

27. The engine pre-heater of claim 21, wherein the housing comprises a plurality of openings defined therein, each of which are separate from the passage and each having an electric heating element inserted therein.

28. The engine pre-heater of claim 21, wherein the electric heating element is removable.
